(19) United States
(12) Patent Application Publication
(10) Pub. No.: US 2023/0060912 A1
(43) Pub. Date: Mar. 2, 2023

(54) OPTIMIZED WIRE SEPARATOR FOR TWISTED WIRE-PAIR APPLICATIONS

(71) Applicant: Panduit Corp., Tinley Park, IL (US)

(72) Inventors: Paul W. Wachtel, Arlington Heights, IL (US); Ronald A. Nordin, Naperville, IL (US)

(73) Assignee: Panduit Corp., Tinley Park, IL (US)

(21) Appl. No.: 17/411,749

(22) Filed: Aug. 25, 2021

(51) Int. Cl. H01B 11/00

(52) U.S. Cl. CPC H01B 11/002

(57) ABSTRACT

A communications cable has coated conductor wires separated by a wire separator to form a twisted pair configured to maintain a distance of approximately 0.45 mm between the conductors and a characteristic impedance of approximately 100 ohms. The coating on the conductors may be an enamel or other appropriately thin insulating material.

### FIELD OF THE INVENTION

The present invention relates generally to communication cables and more specifically, to communication cables utilizing a separator between wires forming a twisted pair that maintains a specific distance between wires.

### BACKGROUND

Traditional category cabling such as Cat 6a is manufactured using common processes of insulating individual conductors, twinning (twisting) two insulated conductors together to form a twisted pair, and stranding four twisted pairs together to form a cable. The four pairs may be stranded together with a dividing member, or cross web, to create distance between the pairs. In addition, the four pairs may be enclosed circumfrentially by barrier layers such as Matrix Tape to achieve a desired electrical characteristic. Ultimately, the entire cable is enclosed inside an outer jacket. An example of a modem Cat 6a cable such as Panduit’s cable is shown in FIG. 1.

There is a constant desire to reduce the cost and size of category cabling to gain market share and competitive advantages over the competition. Recent advancements in the twinning process have allowed the removal of the dividing member resulting in an optimized cable shown in FIG. 2. This cable design is approaching the limits of size and cost reduction for a cable manufactured by the traditional processes and materials.

### SUMMARY

A communications cable has coated conductor wires separated by a wire separator to form a twisted pair configured to maintain a distance of approximately 0.45 mm between the conductors and a characteristic impedance of approximately 100 ohms. The coating on the conductors may be an enamel or other appropriately thin insulating material.

### BRIEF DESCRIPTION OF THE FIGURES

FIG. 1 shows a cross-sectional view of a prior art cable.

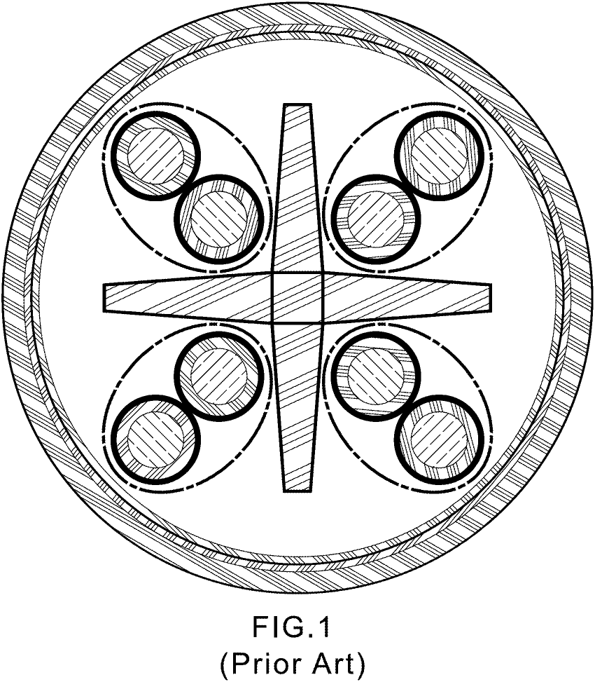

FIG. 2 shows another cross-sectional view of a prior art cable that is similar to FIG. 1 but with the dividing member removed.

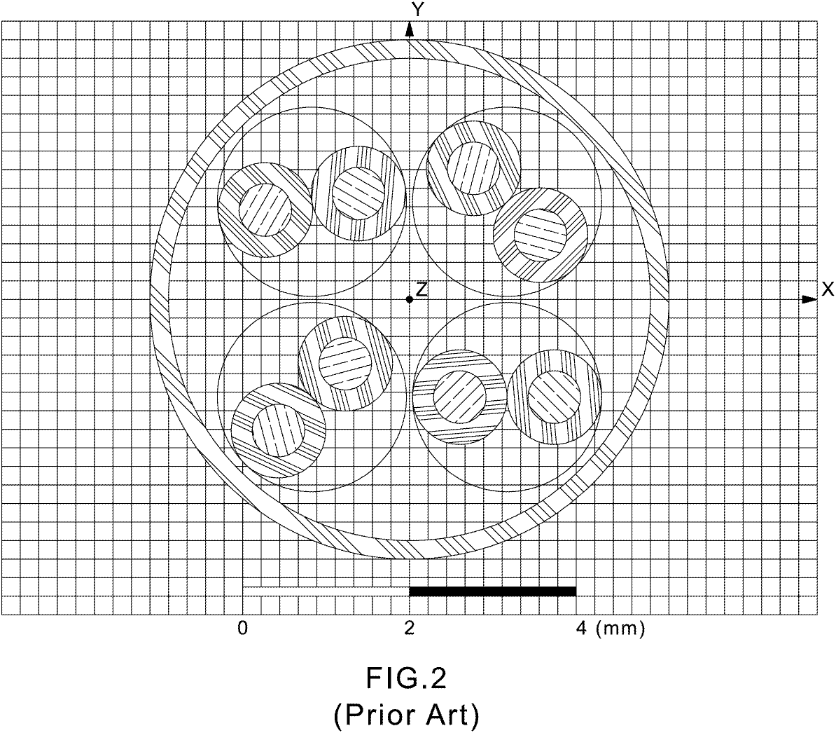

FIG. 3 is a cross-sectional view of a prior art pair of insulated conductors.

FIG. 4 is a cross-sectional view of a pair of conductors separated by a wire separator.

FIG. 5 is a cross-sectional view of a communications cable utilizing the wire separator of FIG. 4.

### DESCRIPTION

Traditional twisted pairs found in Cat 6a cabling are made from two individually insulated conductors. The insulation around the conductor serves two primary electrical purposes. Electrically, it prevents the conductor from shorting to nearby conductors and ensures the cables ability to withstand high DC voltages. The thickness of the insulation also serves the purpose of providing a specific amount of separation between two twisted conductors. This separation is critical to achieve a specific characteristic impedance of the twisted pair when used as a differential transmission line. Typically, this characteristic impedance is targeted to be 100 ohms +/- 10 ohms.

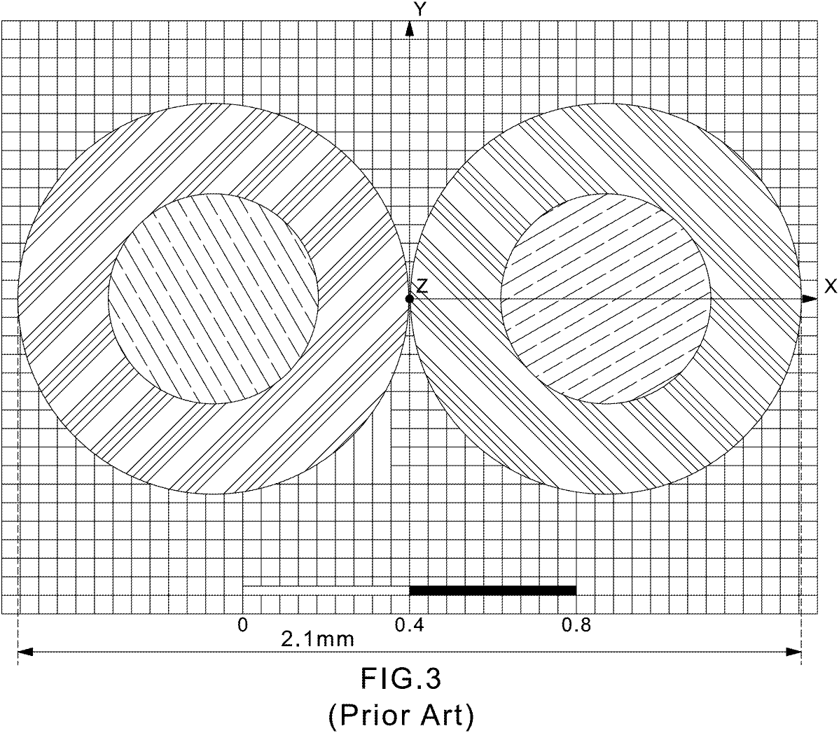

Because the insulation is extruded around the entire circumference of the conductors, the total diameter of the twisted pair orbit (2.1 mm) is determined by the diameter of the insulation surrounding each conductor as shown in FIG. 3.

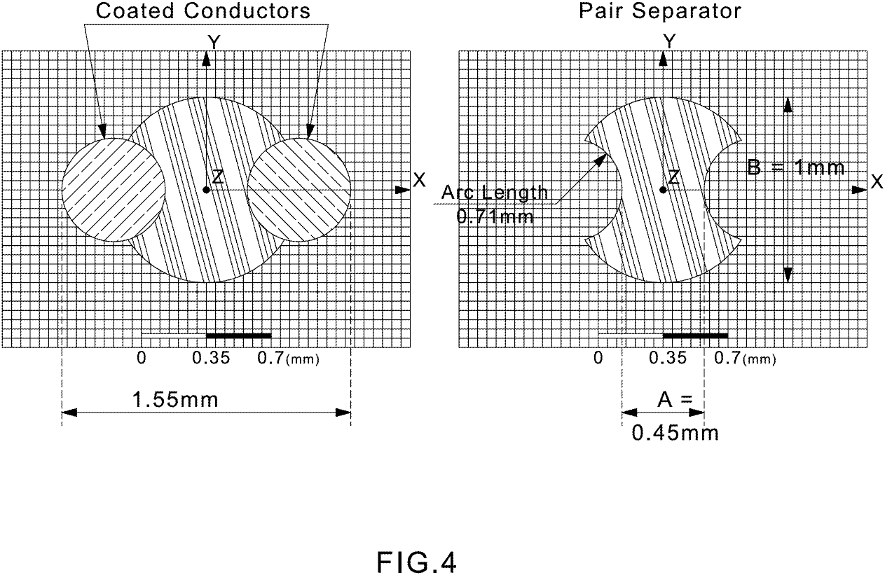

FIG. 4 shows a novel construction of a twisted pair with two enamel coated conductors with a wire separator positioned between the conductors. The wire separator can be fabricated in a separate manufacturing process such as extrusion and made from an appropriate dielectric material such as FEP, HDPE, or others. These same materials are also used in traditional wire insulation processes, and therefore suitable for Cat 6a cable applications. Based on the known material properties, the critical dimension of the pair separator, which defines the spacing between the conductors, was calculated to be 0.45 mm for a HDPE dielectric. A wire separator fabricated from other materials may result in critical dimensions different than 0.45 mm.

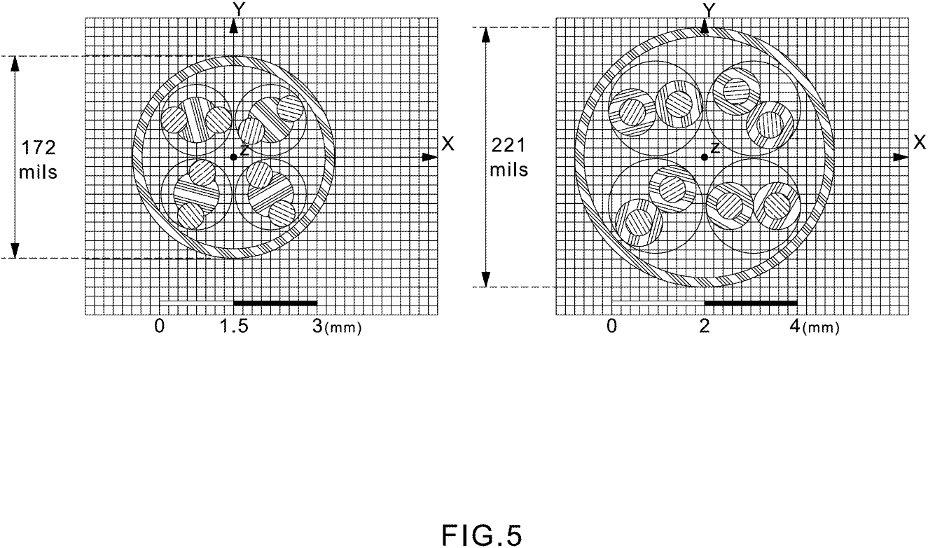

The novel twisted pair orbit diameter (1.55 mm) is now determined by the diameter of the coated conductors and the critical dimension of the wire separator shown in FIG. 4. Compared to a traditional twisted pair construction, the orbit diameter is substantially smaller. Translating these dimensions into a four pair cable design shows a significant potential for size reduction as shown in FIG. 5.

In addition to the reduction in size, the amount of dielectric insulating material is substantially reduced by implementing the novel twisted pair construction. The profile of the pair separator shown in FIG. 4 has a surface area of 893 mils² per pair; therefore, the total volume of insulating material within a 100 meter four pair cable is approximately 719 cubic centimeters. The profile of traditional insulated conductors as shown in FIG. 3 has an insulation surface area of 1708 mils² per pair; therefore, the total volume of insulating material within a 100 meter four pair cable is approximately 1375 cubic centimeters. A reduction of 48% in insulation material is achieved by implementing a cable with novel twisted pairs.

This reduction in insulation material volume is very significant to the overall cost, especially for plenum rated cables where the wire insulation is typically the most expensive raw material in the cable.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A communication cable comprising:
at least one pair of enamel-coated conductors; and
a wire separator between each conductor of the at least one pair of conductors configured to simultaneously maintain a set distance between the conductors and a specific characteristic impendence.

2. The communication cable of claim 1 wherein the distance between the pair of conductors is approximately 0.45 mm and the characteristic impedance is approximately 100 ohms.

3. The communication cable of claim 2 wherein the profile of the pair separator has a surface area of approximately 893 mils².

4. The communication cable of claim 1 wherein the at least one pair of 1 coated conductors is four pairs of coated conductors leading to an outside diameter of the communications cable of approximately 172 mils.
